(19) United States
(12) Patent Application Publication
(10) Pub. No.: US 2015/0159882 A1
(43) Pub. Date: Jun. 11, 2015

(54) DOMESTIC APPLIANCE

(71) Applicant: MIELE & CIE. KG, Guetersloh (DE)

(72) Inventor: Volker Heinz, Obernkirchen (DE)

(21) Appl. No.: 14/551,121

(22) Filed: Nov. 24, 2014

(30) Foreign Application Priority Data
Dec. 6, 2013 (DE) 102013113620.6

(51) Int. Cl. F24C 15/00; A47J 36/32

(52) U.S. Cl. CPC F24C 15/006; A47J 36/32

(57) ABSTRACT

A domestic appliance comprising at least one rotary device disposed on a driveable shaft device. The at least one sensor device is configured to sense at least one rotational movement. At least part of the sensor device is disposed on the rotary device.

### CROSS-REFERENCE TO RELATED APPLICATIONS

Priority is claimed to German Patent Application No. DE 10 2013 113 620.6, filed on Dec. 6, 2013, the entire disclosure of which is hereby incorporated by reference herein.

### FIELD

The present invention relates to a domestic appliance and in particular to a cooking appliance having at least one sensor device.

### BACKGROUND

Domestic appliances, for example ovens, often have various electronic components. These components are usually used for controlling and regulating appliance functions. Often, electronic components also make a domestic appliance easier to use. For example, displays are often used for showing a range of device information and digital arithmetic units allow for operating sequences that are automated and can be selected individually by the user. In modern cooking appliances, for example, as well as conventionally adjusting a cooking temperature, the user can also select and adjust temperature profiles and additional characteristics of a cooking process.

The electronic components are generally heat-sensitive and must therefore be cooled or protected from heat. Cooling of the appliance is therefore very important in particular in domestic appliances comprising heat sources, for example in cooking appliances. For this purpose, fans are often used in cooking appliances, which fans suck air from the surroundings of the cooking appliance and blow this air along the components to be cooled. Subsequently, the warmed air is conducted away back into the surroundings of the cooking appliance.

Overheating of the electronic components generally leads to significant deterioration of the functioning or even to the destruction of the component parts. It is therefore very important to monitor the functioning of the cooling of the appliance. If a failure of the cooling of the appliance is registered, a safety state may for example be triggered, which results in the heat source being switched off. For example, a monitoring device can monitor the functioning of the fan and thus ensure that a sufficiently cooling airstream is present during operation of the heating source.

It is also often necessary to ensure the functioning in other rotating devices.

### SUMMARY

In an embodiment, the present invention provides a domestic appliance comprising a rotary device disposed on a driveable shaft device. A sensor device is configured to sense at least one rotational movement. At least part of the sensor device is disposed on the rotary device.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic side view of a domestic appliance according to the invention;

FIG. 2 is a schematic front view of a flow device comprising a sensor device; and

FIG. 3 is a schematic side view of a flow device comprising a sensor device.

### DETAILED DESCRIPTION

An aspect of the present invention is to provide a domestic appliance which comprises a reliable and uncomplicated sensor device for monitoring the functioning of a rotating device.

The domestic appliance according to the invention is more particularly a cooking appliance and comprises at least one rotary device and at least one sensor device. The rotary device is arranged at least in part on a drivable shaft device. The sensor device is able and configured to sense at least one rotational movement. In this case, at least part of the sensor device is arranged on the rotary device.

The domestic appliance according to the invention has many advantages. A significant advantage is that the domestic appliance has at least part of the sensor device arranged on the rotary device. The rotational movement of the rotary device can thus be sensed independently of the rotational movement of the shaft device on which the rotary device is arranged.

It is particularly advantageous that the sensor device can also reliably sense the rotational movement of the rotary device even without rotational engagement or in the event of a loss of the rotational engagement between the shaft device and the rotary device. A sensor device configured in this way is therefore particularly reliable and permits the rotational movement to be accurately detected. A sensor device not according to the invention which senses a rotational movement of the shaft device and derives therefrom the rotational movement of the rotary device cannot, in the case of an absence of the rotational engagement, correctly detect a rotational movement.

It is possible and preferred for at least part of the sensor device to be arranged in a substantially fixed manner relative to a housing or the like. Part of the sensor device is arranged in a fixed manner in particular relative to the rotary device. The sensor device may, however, also be arranged completely on the rotary device.

The sensor device preferably comprises at least two signal devices. In this case, at least one of the at least two signal devices is arranged on the rotary device. The at least two signal devices are in particular configured and arranged such that a signal can be transmitted between the signal devices. The rotational movement can be classified at least in part on the basis of the signal. The signal can be of an electrical, inductive, electronic, digital, analogue, magnetic and/or electromagnetic type. The signal can, however, also be transmitted mechanically.

In a particularly preferred configuration, at least one of the at least two signal devices is configured as or comprises a signal receiving device and at least one of the at least two signal devices is configured as or comprises a signal generating device. In particular, the signal generating device is fixed to the rotary device and rotates together with the rotary device. In this case, the rotational movement of the signal generating device substantially corresponds to the rotational movement of the rotary device.

The signal receiving device is preferably arranged spaced apart from the signal generating device and does not rotate with the rotary device. The distance here is selected so that the signal can be transmitted in an appropriate manner between the signal devices. It is, however, also possible for the signal devices to be arranged in the reverse manner. In this case, the signal receiving device is then fixed to the rotary device and the signal generating device does not rotate with the rotary device.

The sensor device is in particular configured and able to sense a rotational speed of the rotary device. For example, the signal generating device can output at least one signal which is detected by the signal receiving device and is in particular detected when the signal generating device moves past the signal receiving device. In this case, the signal generating device is preferably non-rotatably attached to the rotary device, so that a signal can be detected by the signal receiving device upon rotation of the rotary device. A configuration of this type permits simple and uncomplicated detection of the rotational speed of the rotary device.

The sensor device can also be configured and able to sense at least one other parameter and/or at least one other feature which is characteristic of a rotational movement. For example, a direction of rotation and/or an angle of rotation can be detected, and/or it can be detected whether the rotational movement is continuous or non-continuous.

The sensed parameters and/or features can be relayed by the sensor device to at least one electronic device, and in particular to at least one evaluation device, and be processed thereby. It is, however, also possible for the sensor device to process the sensed parameters and/or features itself and/or for the sensor device to comprise at least one evaluation device and/or the like.

Particularly preferably, it is possible for the evaluation device to determine whether a particular rotational speed and in particular a minimum rotational speed is sensed. A comparison with another parameter and/or another rotational speed value, for example with a predetermined rotational speed and/or with the rotational speed of a motor and in particular the motor which is provided to drive the rotary device, is also possible.

In an advantageous configuration, the rotary device comprises at least one impeller device and/or is configured as such a device. The impeller device can be used to convey fluids, such as various gaseous media and/or liquid media. The impeller device can be configured as a ventilation wheel, a propeller, an airscrew, a rotor, a turbine, a marine screw propeller, a paddle wheel/waterwheel, a rotary wheel and/or the like. The rotary device can, however, also be configured as any other type of rotatable device and/or comprise such a device or be a part of such a device. The rotary device may, for example, be configured as a rotary plate for a microwave cooking appliance. It is also possible for the rotary device to be formed as a rotary switch, a dial and/or a toggle.

The domestic appliance can also comprise at least one flow device, the flow device being in particular able and configured to transfer fluid in a flow movement or to convey fluids. In this case, the rotary device and in particular the impeller device can be a part of the flow device. The flow device can for example be configured as a ventilation device and/or as a cooling fan, a fan, a ventilating fan, a compressor and/or the like. A ventilation device may be formed axially, radially or tangentially. However, a flow device configured as a pump device, for example a lobe pump, a rotary piston pump, a gear pump and/or the like, is also possible.

According to a particularly preferred configuration, at least one signal device is attached to the impeller device. In particular, a signal generating device is fixed to the impeller device. It is, however, also possible for a signal receiving device to be fixed to the impeller device. A configuration of this type permits reliable sensing of the rotational movement and in particular the rotational speed of the impeller device, since the rotational movement is detected directly on the impeller device and not indirectly via the rotational movement of the shaft device. A loss of rotational engagement between the impeller device and the shaft device can thus be detected and does not lead to distortion of the sensed rotational movement.

It is possible and preferred for the signal receiving device to comprise at least one electrical coil device and/or to be configured as such a device. The coil device is preferably operatively connected to the evaluation device.

It is also possible and preferred for at least one signal generating device to comprise at least one magnet device or to be configured as such a device and/or for at least a part of said device to have magnetic properties. In this case, the magnet device is preferably configured as a permanent magnet and in particular a multi-polar magnet. The magnet device can be fixed to and/or inserted in the rotary device at least in part. At least one balancing weight may be provided on a side of the rotary device opposite the magnet, which prevents an imbalance of the rotary device. Two magnet devices arranged opposite each other are also possible.

A voltage and/or a voltage pulse can preferably be induced in the signal receiving device and in particular in the coil device by the magnet device. In this case, the voltage is in particular induced at least in part by a rotational movement of the magnet device. The signal receiving device particularly preferably comprises a Hall effect sensor which uses the Hall effect for measuring magnetic fields.

It is also possible that at least one circuit device in the signal receiving device can be activated by the magnet device. The circuit device is in particular a reed switch and/or a reed relay and/or the like. Another circuit device which can be switched by the magnetic pulse of the magnet device and/or in particular comprises at least one reed contact is also possible. In this case, the rotational speed of the magnet device is for example calculated from the frequency with which the magnet device activates the circuit device per unit of time.

In a further preferred configuration, the voltage induced in the signal receiving device by the rotational movement of the magnet device has at least one level and/or at least one frequency. The level and/or the frequency of the induced voltage makes it possible to determine a parameter at least in part or at least one feature of the rotational movement of the magnet device, and in particular the rotational speed of the magnet device.

Particularly preferably, the signal receiving device and in particular the coil device is operatively connected to the evaluation device. The evaluation device can determine the rotational speed of the magnet device from the induced voltage, and in particular from the level and/or the frequency of the induced voltage. If, in this case, the magnet device is rotationally engaged with the rotary device, the rotational movement of the magnet device substantially corresponds to the rotational movement of the rotary device.

A sensor device of this type for detecting a rotational movement comprising a permanent magnet as the signal generating device and an electrical coil device as the signal receiving device is uncomplicated and cost-effective. The permanent magnet can be attached particularly simply to a rotary device, since said magnet can be configured in a compact manner and does not require a power supply. As a result, and due to the wireless signal transmission, complex sliding contacts or the like are not required.

It is possible for the sensor device to be operatively connected to at least one safety device. The safety device monitors in particular the sensed parameters and/or features of the rotational movement. The safety device can output at least one alarm signal and/or at least one service indication.

The alarm signal is preferably optical and/or acoustic. A service indication is also possible, for example on a display, and/or it is possible to transmit the alarm signal and/or the parameter triggering the alarm signal to a service point, for example via the Internet. An alarm signal is triggered and/or a service indication is output in particular when the sensor device senses no rotational movement or too slow a rotational movement.

In a cooking appliance comprising a ventilation device for cooling electronic devices or other components, the safety device can check, for example, whether the rotational speed of the impeller device of the ventilation device is sufficient for the cooling. In order to do this, the safety device compares the rotational speed value received by the sensor device with a preset rotational speed value. A safety state can be triggered if the received rotational speed value is too low. This can result in the heat source and/or the electronic devices and/or the domestic appliance being switched off.

At least one operative connection between at least one control device and/or at least one regulation device and the sensor device and/or the evaluation device can also be provided. For example, a control device of this type can initiate an operation-sensitive or program-sensitive change in the rotational speed of the rotary device. In order to control the adjustment, the rotational speed is detected by the sensor device and fed back to the control device. A configuration of this type having a flexible rotational speed adjustment is advantageous, for example, in a ventilation device in which the rotational speed is intended to be controlled depending on a temperature.

Preferably, at least one of the at least two signal devices can also be arranged on the driveable shaft device. A configuration of this type makes it possible to sense the rotational movement of the shaft device. In conjunction with sensing the rotational movement of the rotary device, the rotational speed of the shaft device can be compared with the rotational speed of the rotary device, for example by the evaluation device and/or by the safety device. This is particularly advantageous, since a deviation of the rotational speeds from each other indicates that the shaft device and the rotary device are not sufficiently rotationally engaged.

The sensor device can also comprise at least one acceleration sensor and/or a centrifugal force sensor. It is also possible for there to be at least one position sensor and/or at least one other sensor which can sense a rotational movement. It is also possible for the sensor device to be formed of at least one sensor of this type and in particular of an acceleration sensor and/or a centrifugal force sensor. In this case, the sensor is attached at least in part to the rotary device and transmits the sensed parameters, preferably wirelessly, to the evaluation device and/or the safety device.

The flow device according to the invention is intended in particular for a domestic appliance and comprises at least one rotary device and at least one sensor device for sensing at least one rotational movement of the rotary device. The rotary device is attached to a driveable shaft device. At least part of the sensor device is arranged on the rotary device. The sensor device of the flow device is preferably configured as described above.

Further advantages and possible applications of the present invention are found in the description of an embodiment which will now be explained with reference to the accompanying figures.

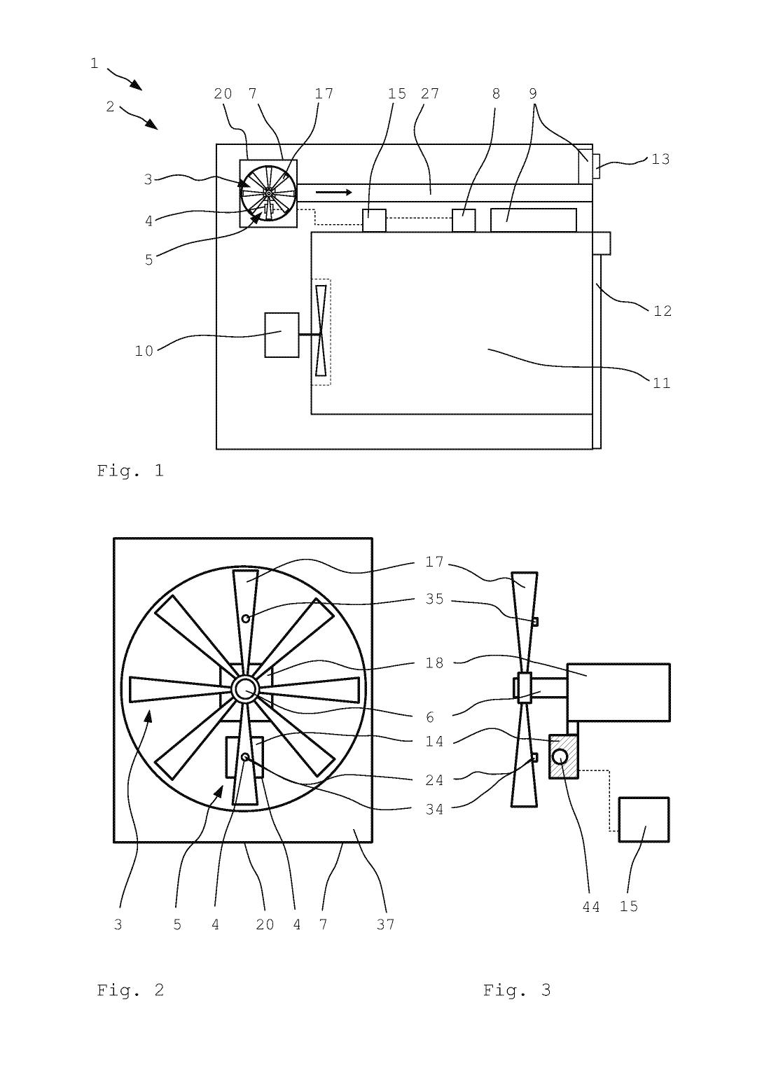

FIG. 1 shows a domestic appliance 1 according to the invention, which is configured here as a cooking appliance 2. A user can operate the cooking appliance 2 by means of an operating unit 13. The cooking appliance 2 comprises a cooking chamber 11 which can be closed by a cooking chamber door 12 and which can be heated by at least one heat source 10 such as a circulating heat source. Further heat sources 10, such as a top heating element and a bottom heating element, as well as a microwave heat source and the like may be provided.

The cooking appliance 2 here comprises two electronic devices 9 which are provided for controlling different functions of the cooking appliance 2 and which permit, for example, program-controlled cooking processes. Other electronic devices 9, such as control devices, displays, touch-sensitive displays, arithmetic units, communication devices and/or the like are also possible.

In this case, the electronic devices 9 are cooled in order to protect them from too much heat and in particular from the heat which is to be expected when the heat source 10 is switched on. The cooking appliance 2 comprises at least one flow device 20 for cooling the electronic devices 9, which is configured here as a ventilation device 7. The ventilation device 7 comprises a rotary device 3 configured as an impeller device 17. The ventilation device 7 sucks in air from the surroundings of the cooking appliance 2 and blows the air through a flow channel 27 along the electronic devices 9 which are cooled thereby. The warmed air is then conducted away back into the surroundings of the cooking appliance 2.

A sensor device 5 serves here to detect the rotational speed of the impeller device 17. The sensor device 5 comprises two signal devices 4, but in order to improve clarity only one is shown here in FIG. 1. The sensor device 5 is operatively connected to an evaluation device 15. At least one wireless connection is also possible. The evaluation device 15 compares the rotational speed detected by the sensor device 5 with at least one preset rotational speed value. It is also possible for the evaluation device 15 to check that a minimum rotational speed is being maintained.

If the rotational speed detected by the sensor device is for example lower than the preset rotational speed value and/or lower than the predetermined minimum rotational speed, it can be assumed that the cooling effect and/or the air stream through the ventilation device 7 is no longer sufficient. The electronic devices 9 could then be subjected to too great a heat and be damaged. In such a case, the heat sources 10 of the cooking appliance 2 are switched off by a safety device 8 which is operatively connected to the evaluation device 15.

At least one monitoring device can also be provided, which for example determines parameters for temperatures in the cooking chamber 11 and/or temperatures in the region of the electronic device 9. The rotational speed of the ventilation device 7 can then be accordingly adjusted to the determined temperatures by a suitable control device in order to ensure sufficient cooling. The sensor device 5 and the evaluation device 15 are configured in a design of this type such that they permit the changed or adjusted rotational speeds to be sensed and monitored.

In FIG. 2, the ventilation device 7 comprising the sensor device 5 and a ventilator housing 37 is shown in greater detail. The impeller device 17 is rotationally engaged with a shaft device 6 configured as a motor shaft and is driven by a motor 18, here taking the form of an electric motor.

The sensor device 5 for detecting the rotational speed of the impeller device 17 here comprises two signal devices 4, one of which is configured as a signal receiving device 14 and one as a signal generating device 24, the signal generating device 24 taking the form of a magnet device 34.

The magnet device 34 here is a permanent magnet which is fixed to a blade of the impeller device 17. In this arrangement, suitable methods of attachment, such as a screw connection, a catch or plug connection, an adhesive connection and/or the like are possible. A balancing weight 35 is attached to a blade which is opposite the blade comprising the magnet device 34. The balancing weight 35 counterbalances the weight of the magnet device 34 and prevents an imbalance of the impeller device 17 during rotation.

FIG. 3 is a side view of the ventilation device 7 of FIG. 2. The ventilator housing 37 has been omitted for the purposes of improved clarity. The signal receiving device 14 comprises an electrical coil device 44 and is arranged such that an electrical voltage pulse can be induced in the coil device 44 by a rotational movement of the magnet device 34.

The evaluation device 15, which is operatively connected to the coil device 44, calculates from the level of the voltage pulses the rotational speed of the magnet device 34 or the frequency at which the magnet device 34 moves past the coil device 44 per unit of time. The rotational speed of the impeller device 17 corresponds to the rotational speed of the magnet device 34.

A domestic appliance 1 designed in this way permits reliable sensing of a rotational movement of a rotary device 3. Even if the rotary device 3 and a shaft device 6 driving the rotary device 3 are no longer rotationally engaged, the rotational movement can be reliably detected, since at least part of the sensor device 5 is arranged on the rotary device 3. The sensor device 5 described above comprising a magnet device 34 and a coil device 44 is in addition uncomplicated and cost-effective to produce and mount.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 Domestic appliance

2 Cooking appliance

3 Rotary device

4 Signal device

5 Sensor device

6 Shaft device

7 Ventilation device

8 Safety device

9 Electronic devices

10 Heat source

11 Cooking chamber

12 Cooking chamber door

13 Operating unit

14 Signal receiving device

15 Evaluation device

17 Impeller device

18 Motor

20 Flow device

24 Signal generating device

27 Flow channel

34 Magnet device

35 Balancing weight

37 Ventilator housing

44 Coil device

What is claimed is:

1. A domestic appliance comprising:
a rotary device disposed on a driveable shaft device; and
a sensor device configured to sense at least one rotational movement;
wherein at least part of the sensor device is disposed on the rotary device.

2. The domestic appliance according to claim 1, wherein the sensor device comprises at least two signal devices and at least one of the at least two signal devices is disposed on the rotary device.

3. The domestic appliance according to claim 2, wherein at least one of the at least two signal devices comprises a signal receiving device and at least one of the at least two signal devices comprises a signal generating device.

4. The domestic appliance according to claim 1, wherein the sensor device is configured and able to sense a rotational speed of the rotary device.

5. The domestic appliance according to claim 1, wherein the rotary device comprises at least one impeller device.

6. The domestic appliance according to claim 1, wherein at least one flow device is provided.

7. The domestic appliance according to claim 5, wherein at least one signal device is attached to the impeller device.

8. The domestic appliance according to claim 3, wherein the signal receiving device comprises at least one electrical coil device.

9. The domestic appliance according to claim 3, wherein at least one signal generating device comprises at least one magnet device.

10. The domestic appliance according to claim 9, wherein the magnet device is configured to induce a voltage in the signal receiving device via a rotational movement of the magnet device.

11. The domestic appliance according to claim 10, wherein the voltage induced in the signal receiving device by the rotational movement of the magnet device has at least one of at least one level or at least one frequency from which at least one parameter of the rotational movement of the magnet device is determinable.

12. The domestic appliance according to claim 1, wherein the sensor device is operatively connected to at least one safety device, the at least one safety device being configured to output at least one of an alarm signal or a service indication, said signal or indication being output when the sensor device senses one of no rotational movement or too slow a rotational movement.

13. The domestic appliance according to claim 2, wherein at least one of the at least two signal devices is disposed on the driveable shaft device.

14. The domestic appliance according to claim 1, wherein the sensor device comprises at least one of at least one acceleration sensor or at least one centrifugal force sensor.

15. The domestic appliance according to claim 1, wherein the domestic appliance is cooking appliance.

16. The domestic appliance according to claim 3, wherein at least part of the at least one signal generating device comprises magnetic properties.

17. The domestic appliance according to claim 11, wherein the at least one parameter of the rotational movement of the magnet device is the rotational speed of the magnetic device.

18. A flow device for a domestic appliance, the flow device comprising:
a rotary device; and a sensor device configured to sense at least one rotational movement of the rotary device, the rotary device being attached to a driveable shaft device;
wherein at least part of the sensor device is disposed on the rotary device.
